(19) United States
(12) Patent Application Publication
(10) Pub. No.: US 2016/0364375 A1
(43) Pub. Date: Dec. 15, 2016

(54) CONTENT DEVELOPMENT REVIEW SYSTEM

(71) Applicant: Disney Enterprises, Inc., Burbank, CA (US)

(72) Inventors: Benjamin White, Burbank, CA (US); Benjamin Bennett, North Hollywood, CA (US); Steven McLurkin, Santa Clarita, CA (US); Tarun Malhotra, Pasadena, CA (US); Ravi Madugula, Burbank, CA (US)

(73) Assignee: Disney Enterprises, Inc., Burbank, CA (US)

(21) Appl. No.: 14/735,036

(22) Filed: Jun. 9, 2015

(51) Int. Cl. G06F 17/25; G06F 17/22; G06F 17/24; G06K 9/62; G06T 11/60

(52) U.S. Cl. CPC G06F 17/25; G06K 9/6201; G06T 11/60; G06F 17/241; G06F 17/2288

(57) ABSTRACT

A process and apparatus provide a content development review system. The process and apparatus perform, with a processor, automatic testing of a page of content. Further, the process and apparatus automatically capture, with the processor, an image of the page of content during the automatic testing. In addition, the process and apparatus display, with the apparatus, the captured image and a development image such that the captured image and the development image are in proximity to each other. The process and apparatus also display, with the processor, an annotation that is indicative of a comparison of the captured image and the development image. Further, the process and apparatus automatically compare, with the processor, the captured image and the development image.

### BACKGROUND

1. Field

This disclosure generally relates to the field of content development. More particularly, the disclosure relates to content development for display of content on a computing device.

2. General Background

Prior to launching a product having a plurality of interconnected pages, e.g., a website, a mobile device application, etc., a development team uses a review process to ensure that there are no defects in the content of the pages. The review process is referred to as internal page review (“IPR”). Previous IPR solutions necessitated that development team reviewers would have to review each page prior to launch manually on several different devices and several different browsers to ensure that there were no defects on each compliant device and each compliant browser. This process involved checking out each device from a shared library, navigating to the particular page to be reviewed on that device, taking screenshots of portions of the reviewed page, and extracting the screenshots from the device, e.g., via e-mail. As the screenshots would only be taken for portions of the reviewed page, those portions would then have to be combined together using an image editing software program to proceed with the review process. The development team reviewers could then annotate the recomposed page with suggested changes to remove any defects prior to launch.

The previous IPR process would have to be iterated through the same content often on many devices to account for different types of devices, e.g., smartphone or tablet device, different operating systems, different screen dimensions, etc. After that iteration had been completed, multiple iterations on each device were then necessary to account for different types of compliant browsers. In other words, one iteration was necessary on each device followed by multiple iterations on each device to account for different browsers. In some instances, the entire IPR process would have to be iterated through again one or more additional times if a significant amount of defects were detected or a significant amount of changes needed to be verified again.

As development teams are often concerned with launch of the developed content, they typically concentrate more on preparation of the content rather than the manually labor intensive IPR process. As a result, visual defects in the launched content would possibly go unnoticed.

Further, the previous IPR solutions required an extensive library of different devices. Content development reviewers were limited in their attempts to complete their review based upon what devices were or were not available for use when they wanted to perform an IPR review.

Therefore, previous IPR solutions used a cumbersome and manually intensive process that often led to delays in launching content development for a computing device and possible visual defects in the launched content that would go unnoticed. An automated content development system that reduces the amount of manual work involved in the IPR process is needed.

### SUMMARY

A process and apparatus provide a content development review system. The process and apparatus perform, with a processor, automatic testing of a page of content. Further, the process and apparatus automatically capture, with the processor, an image of the page of content during the automatic testing. In addition, the process and apparatus display, with the apparatus, the captured image and a development image such that the captured image and the development image are in proximity to each other. The process and apparatus also display, with the processor, an annotation that is indicative of a comparison of the captured image and the development image.

Further, a process and apparatus provide another content development review system. The process and apparatus perform, with a processor, automatic testing of a page of content. Further, the process and apparatus automatically capture, with the processor, an image of the page of content during the automatic testing. In addition, the process and apparatus display, with the processor, the captured image and a development image such that the captured image and the development image are in proximity to each other. The process and apparatus automatically compare, with the processor, the captured image and the development image. The process and apparatus also display, with the processor, an annotation that is indicative of the comparison.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a content review system that provides IPR.

FIG. 2 illustrates an expanded view of the performance testing platform illustrated in FIG. 1.

FIG. 3 illustrates an expanded view of the content development platform illustrated in FIG. 1.

FIG. 4 illustrates an expanded view of the content comparison system illustrated in FIG. 1.

FIG. 5 illustrates an example of an expanded view of a screenshot of the display device illustrated in FIG. 4.

### DETAILED DESCRIPTION

A content review system provides an IPR solution with improved processing speed. The content review system uses a testing system to capture images, e.g., screenshots, of various interconnected content pages, e.g., website pages, application pages for mobile devices, etc., as those pages are tested for performance purposes. As an example, the content review system automatically takes screenshots of various pages during a testing process that tests for operational errors affecting performance. The content review system then displays those screenshots to users, e.g., content development reviewers, for annotation during an IPR process.

In contrast with previous IPR solutions, the content review system reduces the total amount of time needed by a content development team to prepare and perform an IPR of a set of content pages, e.g., approximately a seventy five percent improvement in processing speed. The content review system improves the operating performance of computing systems participating in IPR by performing image capture during the testing processes that are already performed for performance purposes. By leveraging the computing resources being used for testing purposes to also perform screen capture, the content review system improves the performance of IPR in a computing environment.

Further, the amount of manual IPR is significantly minimized in the content review system. Rather than having content development reviewers each participate in the iterative process of checking out multiple devices and viewing the same content on different browsers of those different devices, the content review system only uses one device of each type to provide screenshots for image capture. As a result, several different content development reviewers are able to validate content pages simultaneously. Those content development reviewers can also use a single software environment provided by the content review system to perform IPR rather than having to switch back and forth amongst many different software environments to perform screenshot capture, image editing, annotations, and ordering revisions.

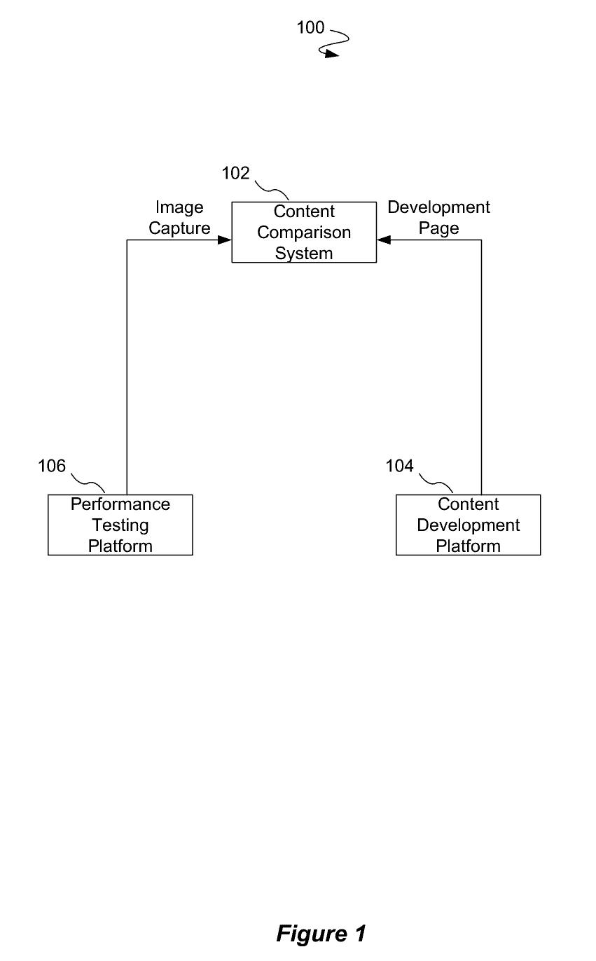

FIG. 1 illustrates a content review system 100 that provides IPR. The content review system 100 has a content comparison system 102 that automatically performs or allows for the performance of a comparison of content pages for IPR. The content development platform 104 provides a development page, i.e., a page that represents what the content development team is using as a basis for a page that is error free, to the content comparison system 102. The development page can be either a screenshot of a page before work was performed or a rendering that is used as a basis for development. The rendering may be generated manually or via a computing device that is capable of performing a rendering. Further, the performance testing platform 106 obtains an image capture, e.g., a screenshot, during performance testing of a page that has been developed by the content development team and needs to be reviewed prior to product launch.

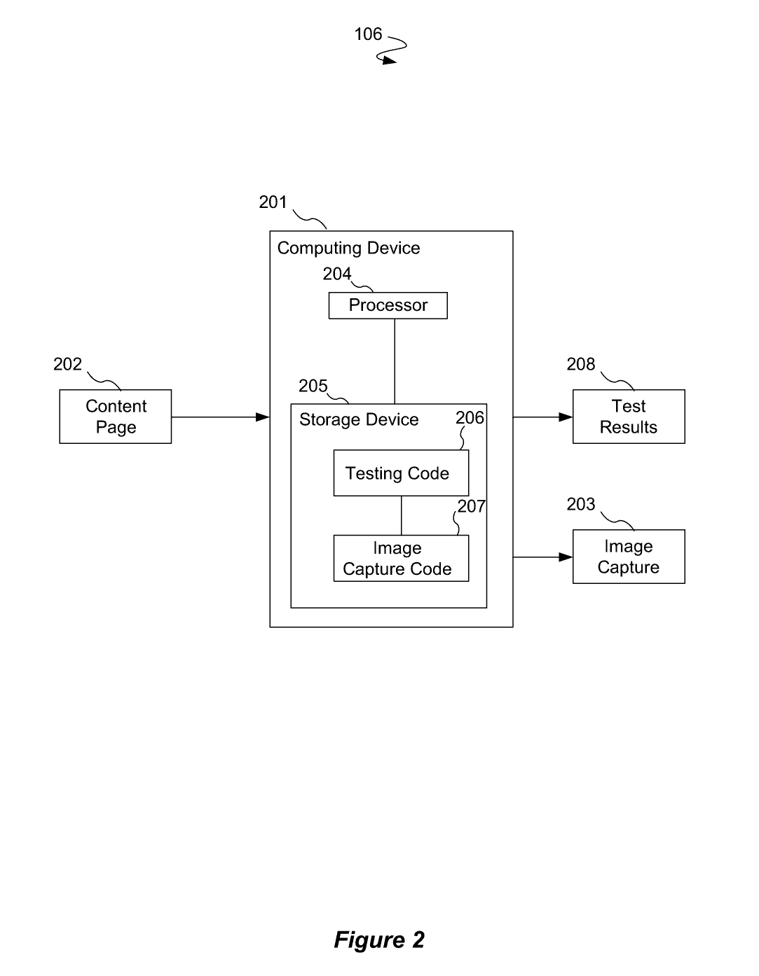

FIG. 2 illustrates an expanded view of the performance testing platform 106 illustrated in FIG. 1. The performance testing platform 106 is used to test the operational performance of a given page. The performance testing platform 106 has a computing device 201 that receives a content page 202 for testing purposes. The computing device 201 includes a processor 204 and a storage device 205. The storage device 205 stores testing code 206 that is used by the processor 204 to perform testing and image capture code 207 that is used by the processor 204 to capture an image, e.g., a screenshot, of the page as it is being tested. For instance, the processor 204 uses the testing code 206 to test each received page, e.g., content page 202, for operational errors. The processor 204 concurrently uses the image capture code 207 to perform image capture during the testing of the content page 202. The performance testing platform 106 then outputs test results 208 and an image capture 203. The test results 208 are used to ensure that the content page 202 performs operationally as necessary whereas the image capture 203 is used for IPR purposes.

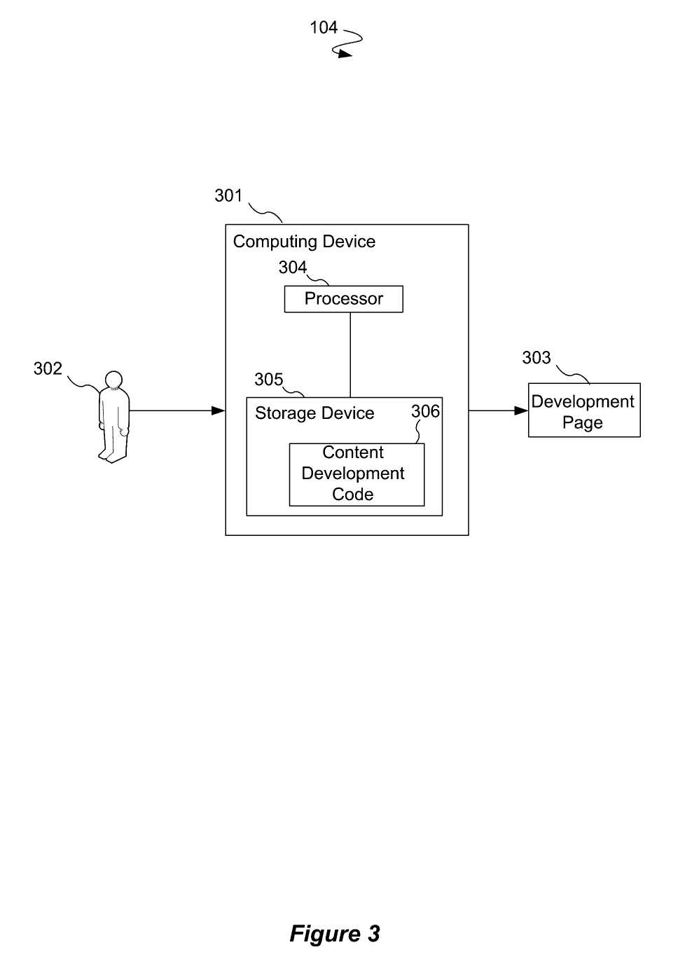

FIG. 3 illustrates an expanded view of the content development platform 104 illustrated in FIG. 1. The content development platform 104 includes a computing device 301 that is used by a user 302, e.g., a content development team member, to generate a development page 303 that is used as a baseline for comparison purposes during IPR. The computing device 301 includes a processor 304 and a storage device 305. The storage device 305 has content development code 306 that is used by the processor 304 to allow the user 302 generate the development page 303.

In one embodiment, the development page 303 is an exact replica of what image captures 203 are supposed to resemble. In another embodiment, the user 302 generates the development page 303 based upon user defined exclusions. For instance, the user 302 may not want certain areas of the image captures 203 to be compared during IPR. For example, the user 302 may indicate that certain coordinates of an image capture 203, e.g., a rectangle at certain x and y coordinates, should have an image present. The user 302 can exclude the content of the image itself from being compared. For example, the user 302 may want to leave a space for changing advertisements without specifying what particular advertisement has to be present. Therefore, the content development page 303 has an indication for a space for an advertisement.

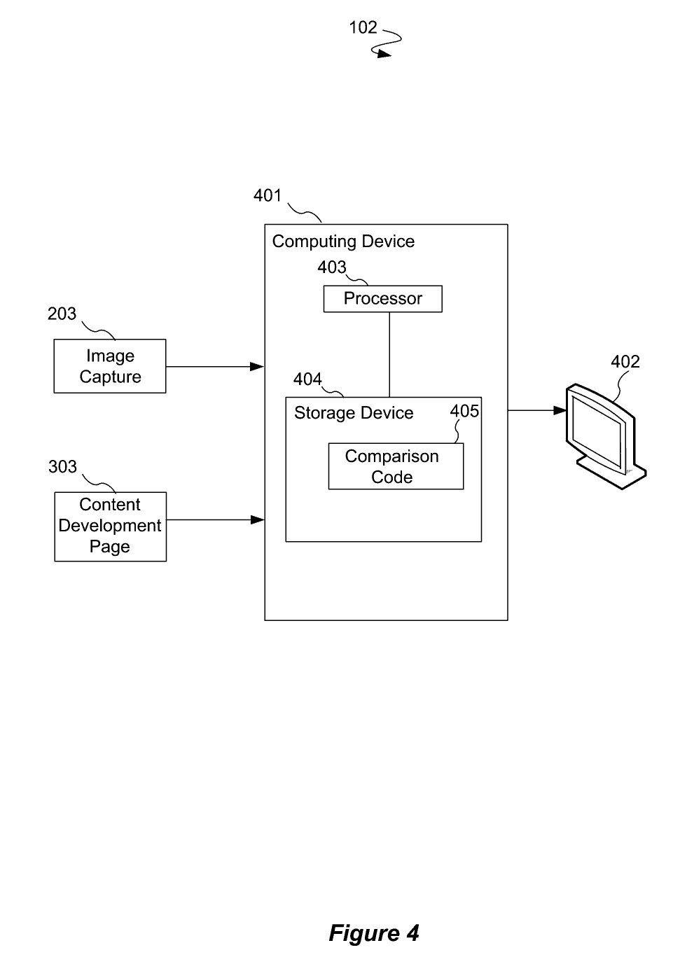

FIG. 4 illustrates an expanded view of the content comparison system 102 illustrated in FIG. 1. The content comparison system 102 has a computing device 401 that receives the image capture 203 and the development page 303 for comparison. The computing device 401 has a processor 403 and a storage device 404. The storage device 403 stores comparison code 405 that is used by the processor 403 to compare the image capture 203 and the development page 303. The computing device 401 then displays the comparison on a display device 402.

The development page 303 may be a screenshot of a page. Further, the image capture 203 may be a subsequent screenshot of that page. The processor 403 may then use the comparison code 405 to compare the image capture 203 to the development page 303, i.e., a screenshot of a page compared with a previous screenshot of that page, to show if the page has changed.

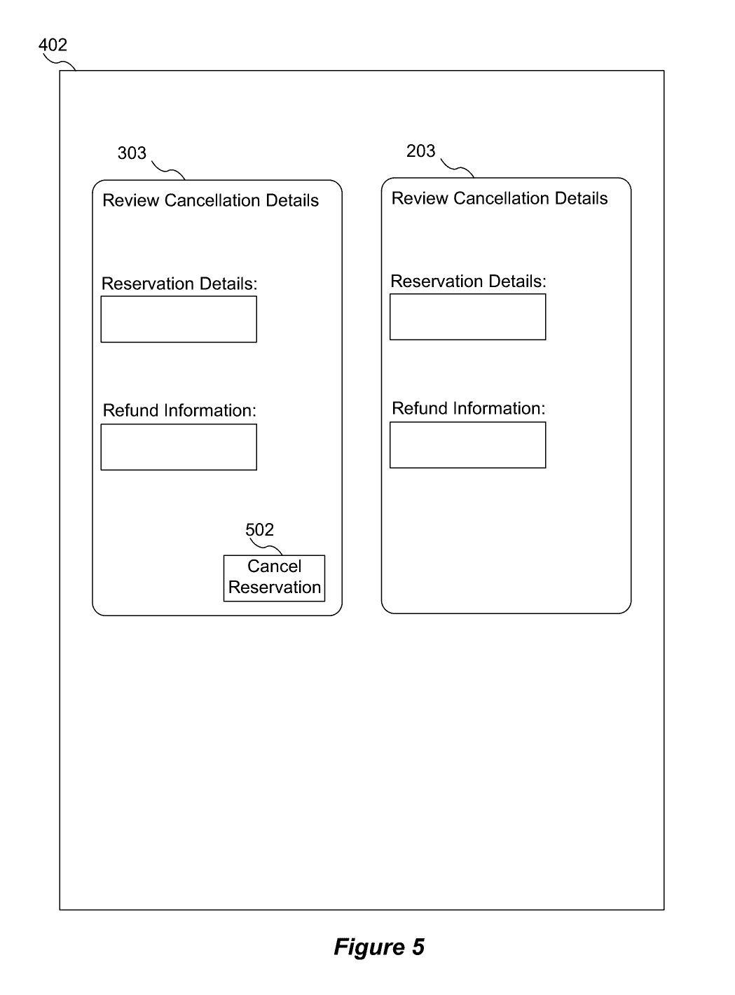

FIG. 5 illustrates an example of an expanded view of a screenshot of the display device 402 illustrated in FIG. 4. The display device 402 displays an example of the development page 303 and the image capture 203. The development page 303 illustrates various content that should also be displayed in the image capture 203. The development page 303 illustrates certain necessary text, e.g., text for cancellation details, and other areas where an image or text should be present without a specification as to the particular image or text that is necessary. In one embodiment, a reviewer can compare the development page 303 and the image capture 203 to determine that the cancel reservation button 502 is present in the development page 303, but not the image capture 203. The reviewer can then annotate the image capture 203 and generate a request to have the captured content page 202 revised based upon the annotation. Further, one of the pages 203 or 303 can be a transparent movable overlay. For instance, the development page 303 can be transparent. The reviewer can then move the development page 303 over the image capture 203 to perform a comparison between the two pages.

In another embodiment, the review process can also be automated with or without a manual verification. For example, the content comparison system 102 can perform an automated comparison between the development page 303 and the image capture 203. The content comparison system 102 can then display annotations on either of the pages 203 or 303 indicating differences between the pages 203 or 303. The content comparison system 102 can then automatically request revisions based upon the detected differences. The content comparison system 102 may or may not necessitate that a manual verification of the automated comparison be performed prior to requesting any revisions.

The development page 303 may either be generated by the content development platform 104 illustrated in FIG. 1 or may be an image capture 203 that was previously approved either automatically or manually. If the development page 303 that was previously approved is determined to be not similar to a subsequent image capture, a manual revision or a manual inspection can be requested.

The configurations provided for herein may be used after content has been developed to validate the content prior to a product launch, but may also be used during content development. For example, a website developer may use the configurations provided for herein to validate that certain features are present on the webpages being developed during the development process.

The processes described herein may be implemented in a general, multi-purpose or special purpose processor. Such a processor will execute instructions, either at the assembly, compiled or machine-level, to perform the processes. Those instructions can be written by one of ordinary skill in the art following the description herein and stored or transmitted on a computer readable storage device. The instructions may also be created using source code or a computer-aided design tool. A computer readable storage device may be any storage device capable of storing those instructions such as a CD-ROM, DVD, magnetic or other optical disc, tape, and/or silicon memory, e.g., removable, non-removable, volatile or non-volatile. A computing device is herein intended to include any device that has a general, multi-purpose or single purpose processor as described above. For example, a computing device may be a personal computer (“PC”), laptop, smartphone, tablet device, set top box, etc.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A method comprising:
performing, with a processor, automatic testing of a page of content;
automatically capturing, with the processor, an image of the page of content during the automatic testing;
displaying, with the processor, the captured image and a development image such that the captured image and the development image are in proximity to each other; and
displaying, with the processor, an annotation that is indicative of a comparison of the captured image and the development image.

2. The method of claim 1, wherein the annotation is associated with the captured image.

3. The method of claim 1, wherein the annotation is associated with the development image.

4. The method of claim 1, further comprising generating a revision request based upon the annotation and routing the revision request to an entity to perform a revision based upon the revision request.

5. The method of claim 1, further comprising displaying the development image as a movable overlay that is positioned over the captured image for comparison.

6. The method of claim 1, further comprising displaying the captured image as a movable overlay that is positioned over the development image for comparison.

7. The method of claim 1, wherein the comparison is performed automatically by the processor.

8. The method of claim 1, wherein the captured image is a screenshot of the page of content.

9. The method of claim 8, wherein the development image is a previous screenshot of the page of content.

10. A method comprising:
performing, with a processor, automatic testing of a page of content;
automatically capturing, with the processor, an image of the page of content during the automatic testing;
displaying, with the processor, the captured image and a development image such that the captured image and the development image are in proximity to each other;
automatically comparing, with the processor, the captured image and the development image; and
displaying, with the processor, an annotation that is indicative of the comparison.

11. The method of claim 10, further comprising receiving, with the processor, an annotation of the development image that is indicative of content in the development image that is excluded during the comparison.

12. The method of claim 10, wherein the development image is a previously approved captured image.

13. The method of claim 10, wherein the annotation is associated with the captured image.

14. The method of claim 10, wherein the annotation is associated with the development image.

15. The method of claim 10, further comprising generating a revision request based upon the annotation and automatically routing the revision request to an entity to perform a revision based upon the revision request.

16. The method of claim 10, further comprising displaying the development image as a movable overlay that is positioned over the captured image for comparison.

17. The method of claim 10, further comprising displaying the captured image as a movable overlay that is positioned over the development image for comparison.

18. The method of claim 10, further comprising retrieving the development image based upon an association of the captured image with a device and a browser.

19. An apparatus comprising:
a processor that performs automatic testing of a page of content, automatically captures an image of the page of content during the automatic testing, displays the captured image and a development image such that the captured image and the development image are in proximity to each other, and displays an annotation that is indicative of a comparison of the captured image and the development image.

20. An apparatus comprising:
a processor that performs automatic testing of a page of content, automatically captures an image of the page of content during the automatic testing, displays the captured image and a development image such that the captured image and the development image are in proximity to each other, automatically compares, with the processor, the captured image and the development image, and displays, with the processor, an annotation that is indicative of the comparison.
